(19) United States
(12) Patent Application Publication
(10) Pub. No.: US 2001/0013846 A1
(43) Pub. Date: Aug. 16, 2001

(54) APPARATUS FOR DRIVING PLASMA DISPLAY PANEL

(76) Inventor: JEUNG HIE CHOE, KYUNGSANGBUK-DO (KR)

Correspondence Address: MORGAN, LEWIS & BOCKIUS, 1800 M STREET NW, WASHINGTON, DC, 20036-5869, US

(21) Appl. No.: 09/197,497

(22) Filed: Nov. 23, 1998

(30) Foreign Application Priority Data
Nov. 22, 1997 (KR) 62191-1997

(51) Int. Cl. G09G 3/28

(52) U.S. Cl. 345/60

(57) ABSTRACT

An apparatus for driving a plasma display panel includes a display panel having a plurality of column electrodes and row electrodes, a row data driver coupled to the row electrodes, and applying video data to the row electrodes, a column scan driver coupled to the column electrodes, and applying scan data to the column electrodes, a control circuit controlling each of system configuration blocks including the row data driver and the column scan driver, X and Y common drivers coupled to the control circuit, and applying driving signals to common electrodes of the display panel, and a power supply circuit for supplying voltages to each of the system configuration blocks.

This application claims the benefit of Korean patent application No. 62191-1997 filed Nov. 22, 1997, which is hereby incorporated by reference.

### BACKGROUND OF THE INVENTION

1. Field of the Invention

The present invention relates to an alternating current (AC) plasma display panel (PDP), and more particularly, to an apparatus for driving a PDP having a reduced size of a driver and improving its performance.

2. Description of the Related Art

Generally, a PDP is discharged by adjusting a voltage applied between a vertical electrode and a horizontal electrode in each cell. The intensity of light in a cell is determined by the discharged PDP and adjusted by varying discharging time in the cell.

An overall screen of the PDP is controlled by driving the PDP in a matrix arrangement by applying a write pulse for inputting a digital video signal to the vertical and horizontal electrodes in each cell, a scan pulse for scanning, and a sustain pulse for sustaining a discharge, and an erase pulse for erasing discharge of the discharged cell.

A conventional PDP will be described with reference to the accompanying drawings. The conventional PDP disclosed in U.S. Pat. No. 5,446,344 is hereby incorporated by reference.

FIG. 1 is a block diagram illustrating an apparatus for driving a conventional PDP. FIG. 2 is a cross-sectional view illustrating a vertical structure in each pixel of a conventional PDP. As shown in FIG. 1, a conventional PDP module includes a display panel 1, an address driver 2, a scan driver 3, a power supply circuit 4, an X-common driver 5, a Y-common driver 6, and a control circuit 7.

Specifically, in the conventional PDP module, the display panel 1 includes row electrode lines Y1, Y2, . . . Yn and column electrode lines A1, A2, . . . Am to drive each of pixels. The address driver 2 applies digital video data to the column electrode lines A1, A2, . . . Am at the display panel 1. The scan driver 3 applies scan data to the row electrode lines Y1, Y2, . . . Yn to determine whether or not the display panel 1 is driven. The X-common driver 5 directly drives common electrodes (not shown in FIG. 1) of the display panel 1, and the Y-common driver 6 applies common voltage into the scan driver 3. The control circuit 7 provides various signals and data required to drive the above drivers. The power supply circuit 4 supplies power to each of the system configuration blocks.

Cells are formed on the display panel 1. Each cell is formed as shown in FIG. 2.

FIG. 2 shows a three-electrode surface-discharge AC PDP cell. The AC PDP cell includes a front glass substrate 9, a rear glass substrate 10, an isolation wall 8, a first insulating layer 12, a column electrode 13, a second insulating layer 14, a protecting layer 15, a fluorescent layer 16, a scan electrode 17, a common electrode 18, and a discharge space 19. The front glass substrate 9 and the rear glass substrate 10 correspond to each other in parallel. The isolation wall 8 isolates each of cells from one another. A row electrode includes the scan electrode 17 and the common electrode 18. The scan electrode 17 and the common electrode 18 are formed in parallel on the second insulating layer 14 of the rear glass substrate 10. The column electrode 13 is formed on the first insulating layer 12 in a matrix arrangement with the row electrode. The first insulating layer 12 is formed on the front glass substrate 9 opposing the rear glass substrate 10. The protecting layer 15 is formed on the second insulating layer 14.

Since the first and second insulating layers 12 and 14 cover the column electrode 13 and the row electrode, respectively, a discharge is erased soon after the discharge occurs by applying a voltage between the row electrode and the column electrode 13. To sustain the discharge, the AC PDP applies an AC voltage, which polarity is continuously reversed, between the row electrode and the column electrode 13.

The protecting layer 15 protects the first and second insulating layers 12 and 14 to lengthen their life and improves emitting efficiency of secondary electrons. For example, a MgO thin film may be used as the protecting layer 15 to prevent discharge characteristics from varying due to contamination of oxidized metal layer.

The fluorescent layer 16 is deposited on the first insulating layer 12. Ultraviolet rays generated by discharge excites the fluorescent layer 16, so that visible rays of RGB (red, green, and blue) occur. A mixture gas of Ar and Xe is charged in the discharge space 19 where the discharge occurs, so as to improve emitting efficiency of the ultraviolet rays.

As shown in FIG. 1, a driver circuit includes an address driver 2 having 3840 shift registers and a scan driver 3 having 480 shift registers (in 640×480 mode). The shift registers of the address driver 2 shift and store video data bits. The shift registers of the scan driver 3 function as shift selectors for line scan.

The conventional PDP module can be driven by various methods. Operation of the conventional PDP module will be described below with reference to FIG. 3 to FIG. 5.

FIG. 3 is a timing chart illustrating a first driving method of a conventional PDP. FIG. 4 is a schematic view illustrating a sub-frame driving mode according to a conventional PDP. FIG. 5 is a schematic view illustrating another sub-frame driving mode of the conventional PDP.

The address driver 2 loads video data from the control circuit 7 to each of address electrodes (column electrode lines A1, A2, . . . Am). The scan driver 3 (row driver) shifts line one by one to select each of lines. When a row (line) is selected, the address driver 2 applies video data from the control circuit 7 to the selected line.

As shown in FIG. 3, data of address electrodes are written in each cell through addressing discharge while row electrodes Y1, Y2, . . . , Yn are shifted. In FIG. 3, the conventional driving method includes a total write and erase period, an addressing period, and a sustain period.

Such a driving method is performed by a sub-frame mode as shown in FIG. 4. In the sub-frame mode, one frame consists of 8 bits or 6 bits. Each of sub-frames includes a total write and erase period, an addressing period, and a sustain period.

Meanwhile, in another sub-frame mode of FIG. 5, each of sub-frames is formed in each line in view of the fact that a sustain period of the most significant bit (MSB) for the video data of 8 bits is the longest and that the sum of the first to seventh sustain period is almost the same as the sustain period of the MSB.

The address electrodes of the display panel includes the odd lines and the even lines. When the odd lines pass through the total write and erase period of 1-7 bits, an addressing period, and a sustain period, the even lines only perform the sustain function.

FIGS. 6 to 8 show other driving method of the conventional PDP. Referring to FIG. 6, an averag level voltage of −Vsc and a scan pulse −Vy are applied to the scan electrode. In FIG. 7, the PDP is driven by adjusting a duration time of a pulse applied to the address electrode in the driving method of FIG. 6. Referring to FIG. 8, write and erase lines instead of the total write and erase period are selected to perform writing and erasing in the selected line.

In the driving methods of the conventional PDP, the column driver (address driver) loads video data to the column electrode in the addressing period. In the row driver (scan driver and Y-driver), scanning in each line is performed while sustain is performed between the common driver (X-electrode) and the row driver.

The driving method in each line is operated similar to scanning method of the conventional CRT (Cathode Ray Tube) and CPT (Color Picture Tube).

Conventionally, a TV, a monitor, or a PDP device for displaying an image has an aspect ratio of 1920:480 (640×480 mode) of 1920 column electrode lines and 480 row electrode lines. As shown in FIG. 16a, the conventional PDP device has the address driver (data driver) driving the row electrode lines and the scan driver driving the column electrode lines. Since the address driver requires two lines of latch devices, the number of latches required in the conventional PDP device are 4320 (i.e., 1920×2 latches for column and 480 latches for row, total of 4320 latches). Therefore, the number of circuits for storing data of the driver increases, so that the cost of an apparatus increases.

### SUMMARY OF THE INVENTION

Accordingly, the present invention is directed to an apparatus for driving a PDP that substantially obviates one or more of the problems due to limitations and disadvantages of the related art.

An object of the present invention is to provide an apparatus for driving a PDP in which the size of a driver is reduced to improve its application in accordance with module and driving methods.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, an apparatus for driving a plasma display panel includes a display panel having a plurality of column electrodes and row electrodes, a row data driver coupled to the row electrodes, and applying video data to the row electrodes, a column scan driver coupled to the column electrodes, and applying scan data to the column electrodes, a control circuit controlling each of system configuration blocks including the row data driver and the column scan driver, X and Y common drivers coupled to the control circuit, and applying driving signals to common electrodes of the display panel, and a power supply circuit for supplying voltages to each of the system configuration blocks.

In another aspect of the present invention, an apparatus for driving a plasma display panel includes a display panel having a plurality of column electrodes and row electodes, a control circuit generating control signals according to externally applied video data, a clock signal, a vertical synchronous signal, and a horizontal synchronous signal, a row data driver latching the video data, and providing a row electrode driving voltage to the row electrodes, a column scan driver coupled to the control circuit and receiving a shift pulse and providing a column electrode driving voltage to the column electrode 5, X and Y common drivers coupled to the control-circuit, and applying driving signals to common electrodes of the display panel, and a power supply circuit for supplying voltages to each of the system configuration blocks.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a block diagram illustrating an apparatus for driving a conventional PDP;

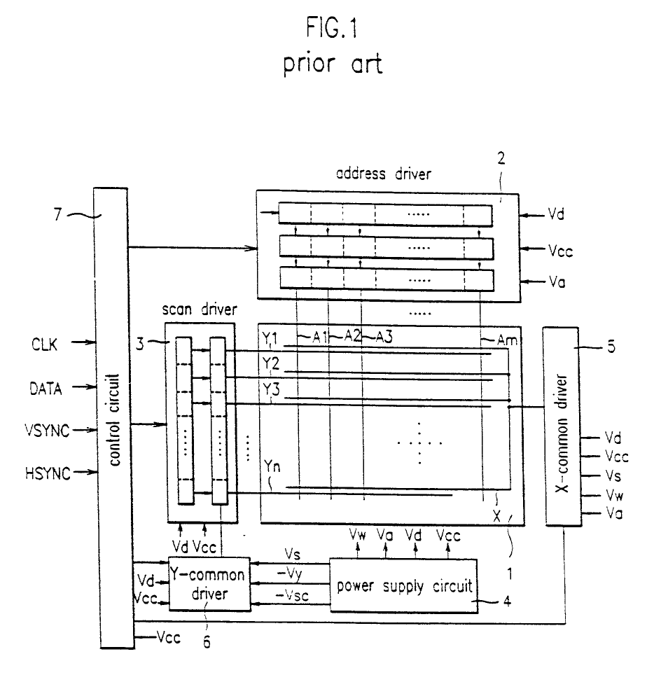

FIG. 2 is a cross-sectional view illustrating a pixel structure of the conventional PDP;

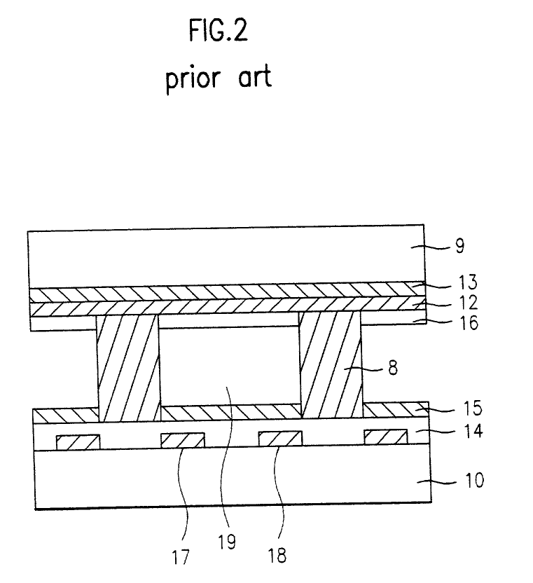

FIG. 3 is a timing chart illustrating a first driving method of the conventional PDP;

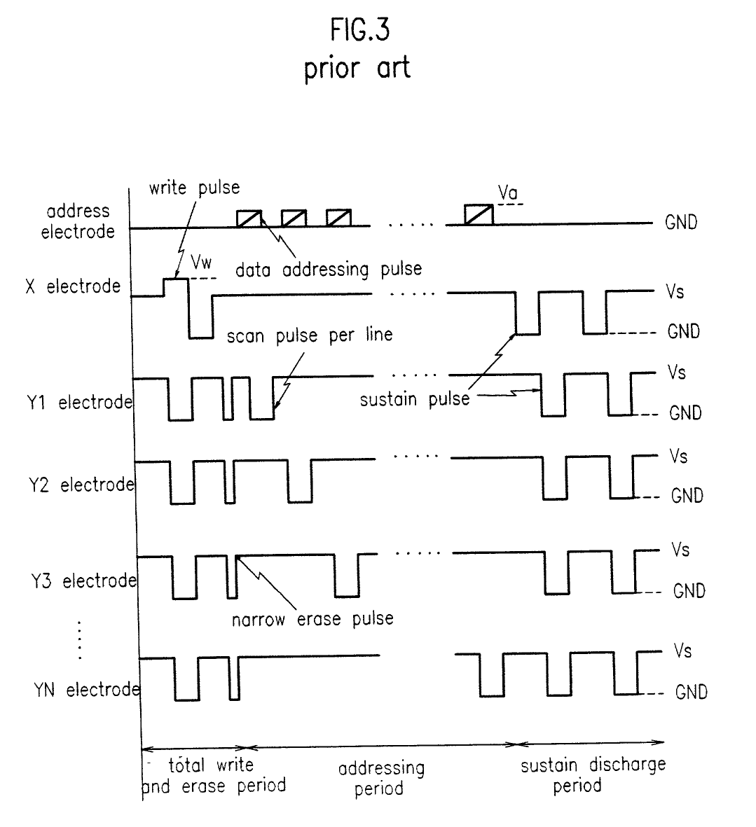

FIG. 4 is a schematic view illustrating a sub-frame driving mode according to the conventional PDP;

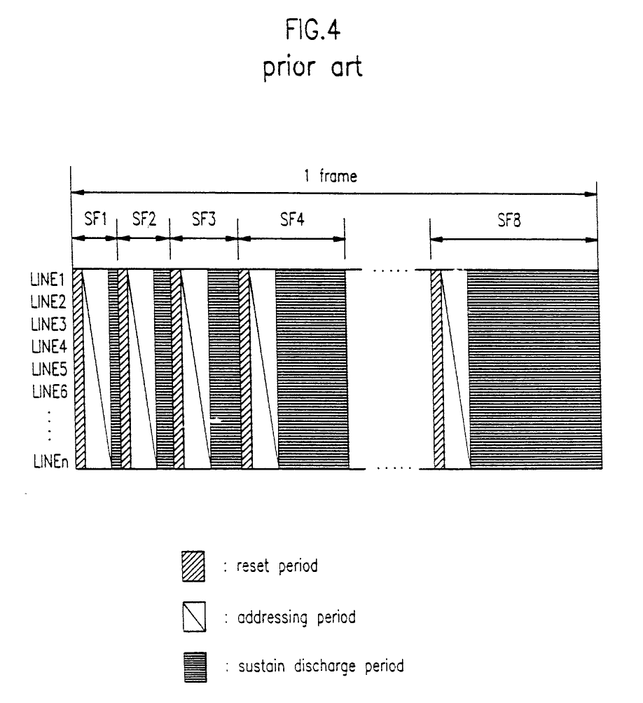

FIG. 5 is a schematic view illustrating another sub-frame driving mode according to the conventional PDP;

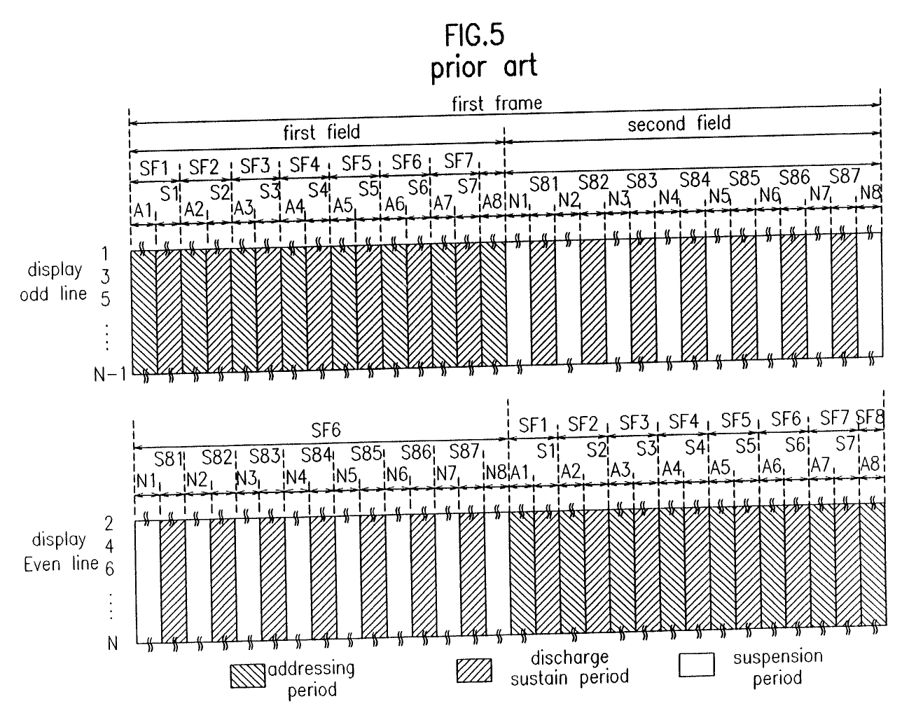

FIG. 6 is a timing chart illustrating a second driving method of the conventional PDP;

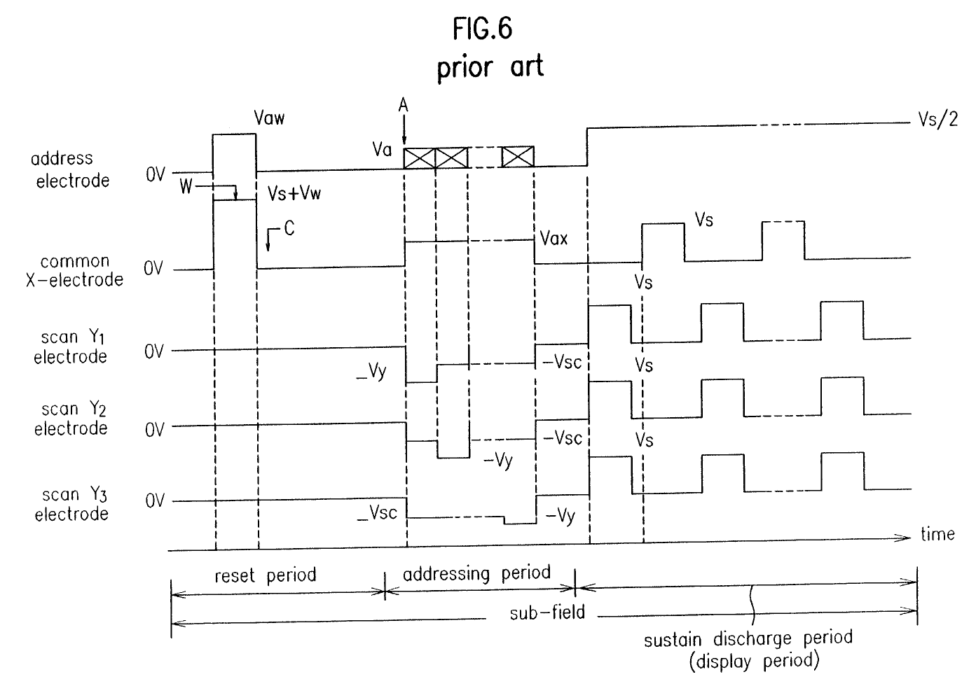

FIG. 7 is a timing chart illustrating a third driving method of the conventional PDP;

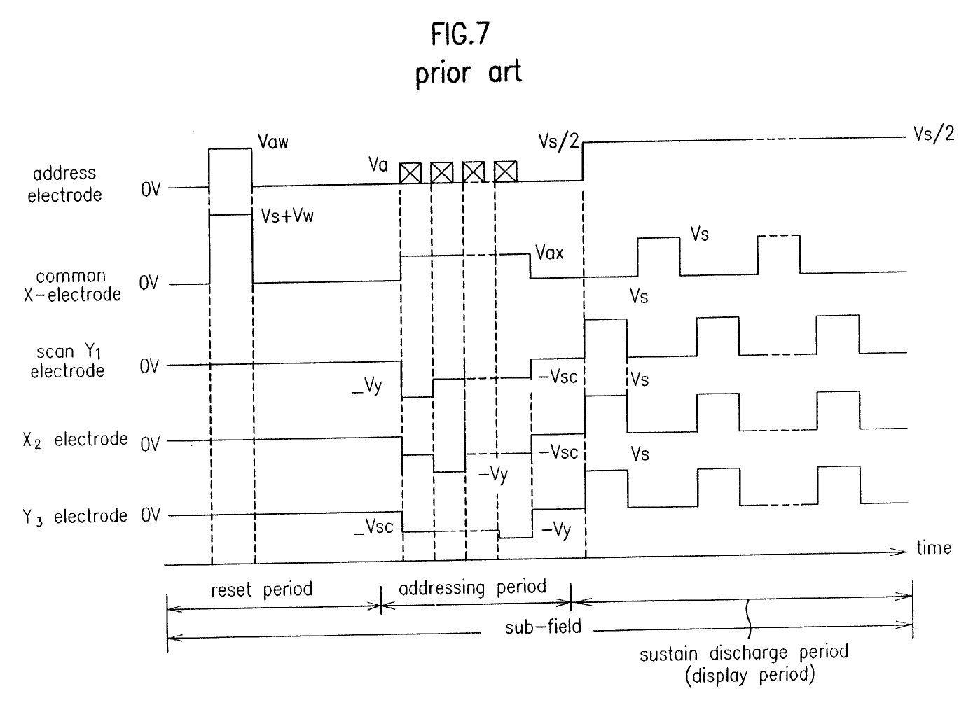

FIG. 8 is a timing chart illustrating a fourth driving method of the conventional PDP;

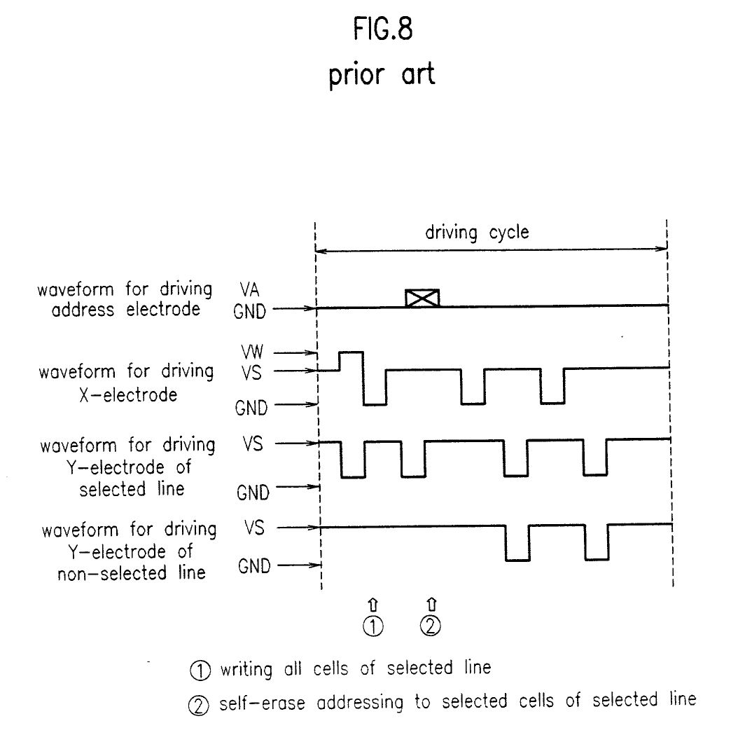

FIG. 9 is a block diagram illustrating an apparatus for driving a PDP according to the present invention;

FIG. 10 is a schematic view illustrating a sub-frame mode according to the present invention;

FIG. 11 is a timing chart illustrating a first driving method of a PDP according to the present invention;

FIG. 12 is a schematic illustrating a driving cycle of a unit cell according to the first driving method of FIG. 11;

FIG. 13 is a timing chart Illustrating a second driving method of a PDP according to the present invention;

FIG. 14 is a schematic illustrating a driving cycle according to the second driving method of FIG. 13;

FIG. 15 is a timing chart of operation illustrating that data loading time is reduced in FIG. 14; and

FIGS. 16a and 16b are comparative views of the number of latches in the apparatus for driving a PDP according to the present invention.

### DESCRIPTION OF THE PREFERRED EMBODIMENT

Reference will now be made in detail to the preferred embodiments of the present invention, examples of which are illustrated in the accompanying drawings.

In the present invention, a scan driver which applies pixel driving signals to a PDP is connected to column electrode lines and a data driver which applies video data signals to the PDP is connected to row electrode lines.

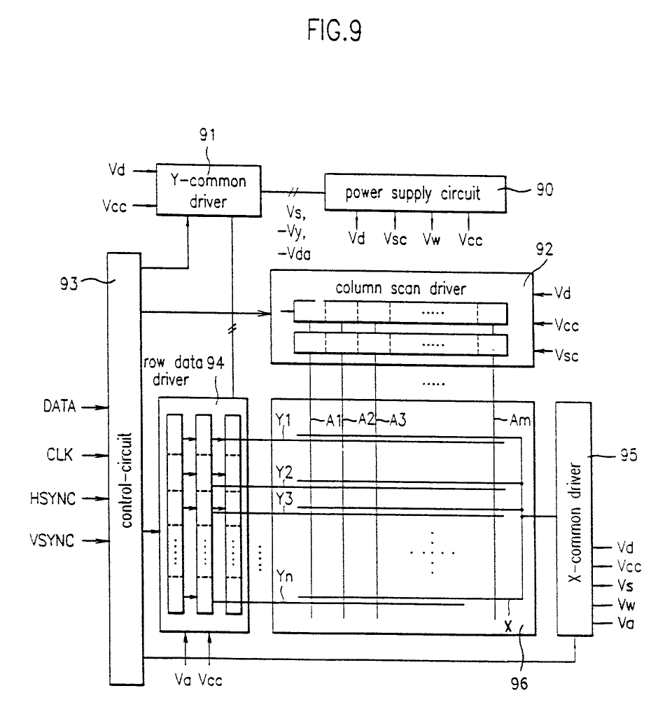

As shown in FIG. 9, an apparatus for driving the PDP of the present invention includes a display panel 96, a Y-common driver 91, a column scan driver 92, a control circuit 93, a row data driver 94, an X-common driver 95, and a power supply circuit 90. The PDP module of the present invention will be described in detail as follows.

The display panel 96 includes row electrode lines Y1, Y2, . . . Ym and column electrode lines A1, A2, . . . Am. The row data driver 94 applies digital video data to the row electrode lines. The column scan driver 92 applies scan data to the column electrode lines to determine whether or not the display panel 96 is driven. The Y-common driver 91 and the X-common driver 95 apply driving signals to common electrodes of the display panel 96. The control circuit 93 controls various signals and data required to drive the above drivers. The power supply circuit 90 supplies voltages to each of system configuration blocks. The voltages include a sustain voltage applied to the X- and Y-common drivers 91 and 95, a voltage for a total writing in each cell, a voltage for a scanning operation for selecting each cell, and a voltage for addressing each cell.

The control circuit 93 receives video data, system clock, a horizontal synchronizing signal HSYNC, and a vertical synchronizing signal VSYNC and sequentially applies to the row electrode lines.

The column scan driver 92 and the row data driver 94 include a register in each internal circuit. In case of 640×480 mode, the column scan driver 92 includes 1920 registers and the row data driver 94 includes 960 registers.

The registers of the column scan driver 92 function as shift selectors for line scan. The registers of the row data driver 94 shift and store video data bits.

Operation of the apparatus for driving the PDP according to the present invention will be described as follows.

The row data driver 94 receives video data from the control circuit 93 and loads to the row electrode lines. The column scan driver 92 shifts each of the column electrode lines one by one. When one of the column electrode lines is selected by the column scan driver 92, the row data driver 94 latches the video data from the control circuit 93 and loads the video data into the row electrode lines through the addressing discharge.

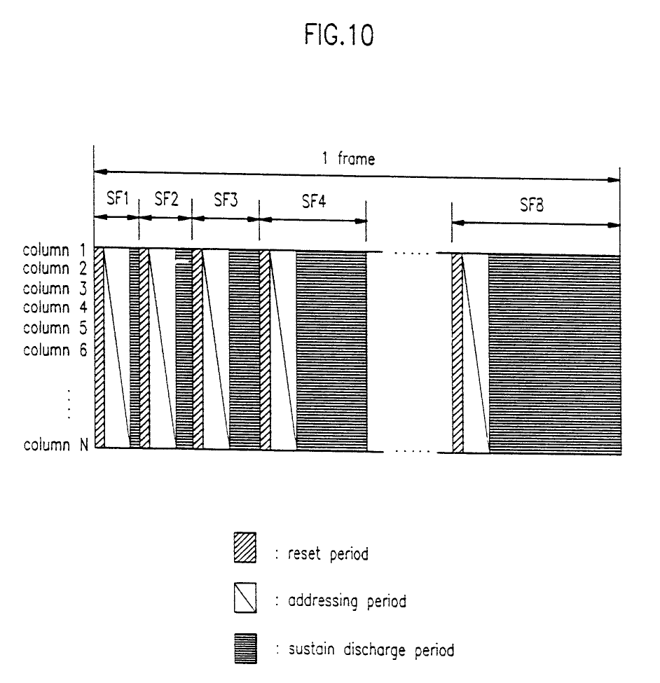

Operating methods of the apparatus for driving the PDP of the present invention, which performs the data loading operation, will be described with reference to FIGS. 10 to 15.

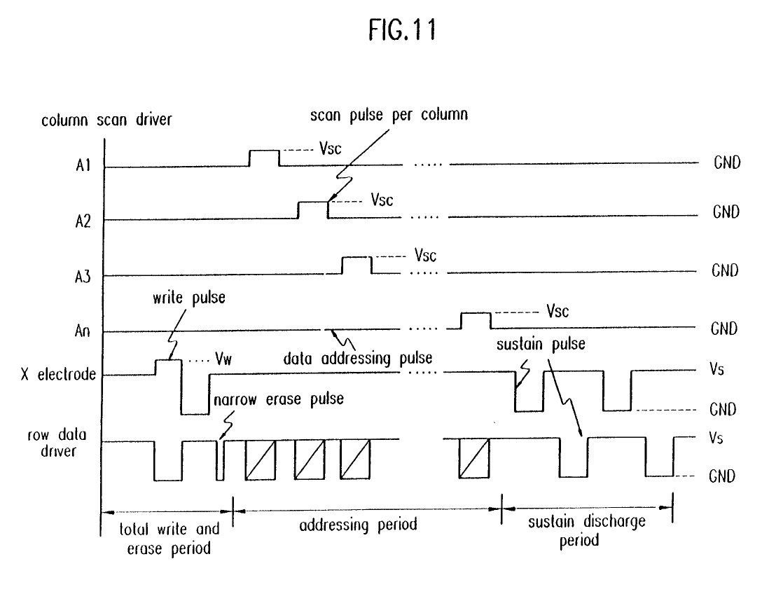

FIG. 11 shows an operation cycle of the data loading operation. Such operation cycle includes a total write and erase period, an addressing period, and a sustain discharge period. In this case, the apparatus for driving the PDP is driven in accordance with a reference voltage Vs between the X electrode and the row electrode. Signal of the X-common driver 95 is applied to the X electrode, while the row data is applied to the row electrode.

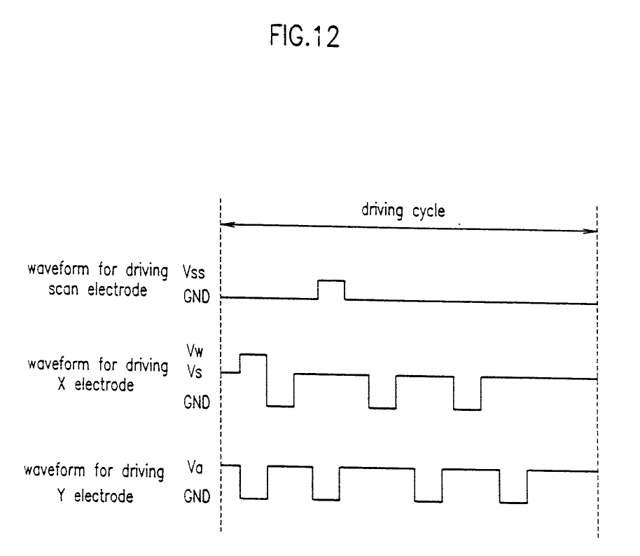

FIG. 12 shows a driving cycle in the operation cycle of FIG. 11. In driving operation in each cell, the addressing discharge occurs between the column electrode and the row electrode while the sustain discharge occurs between the row electrode and the X electrode.

As shown in FIG. 10, the PDP of the present invention is driven by a column sub-frame mode. The column sub-frame mode includes a reset period and a sustain discharge period. In the column sub-frame mode, data loading is performed in each column. That is, a scan driving operation is performed by selecting the Y electrode lines.

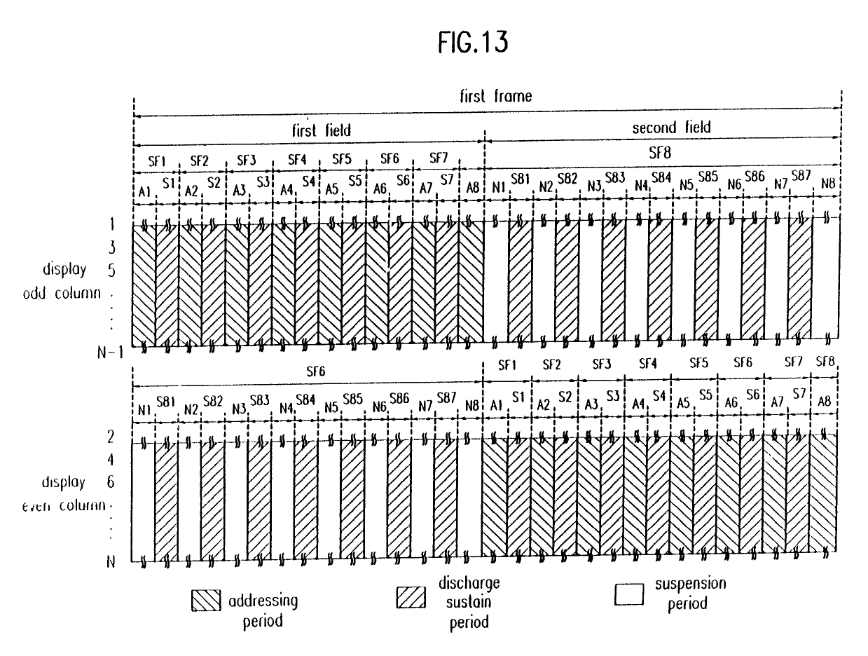

FIG. 13 shows a second driving method of the PDP module according to the present invention. Referring to FIG. 13, the column electrodes used as the scan electrode are divided into the odd column lines and the even column lines. The even column line performs a sustain function in the sustain period corresponding to the MSB when 1-7 bits data of the odd column lines are sustained.

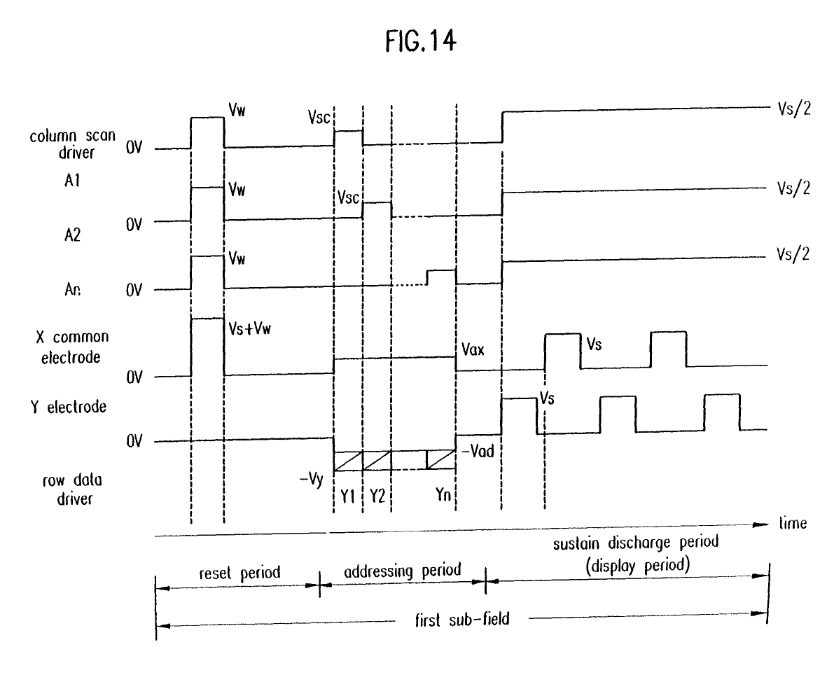

FIG. 14 shows a driving cycle according to the second driving method of FIG. 13. In FIG. 14, voltage levels of each of the electrodes are adjusted. Pulse is not applied to the row electrodes where the video data are applied during the reset period. The pulse is applied to the common electrodes and the column electrodes where the scan operation is performed, so that the total writing is performed. In this driving method, the column electrode lines are driven during the scan operation and the row electrode lines are driven during the data loading operation.

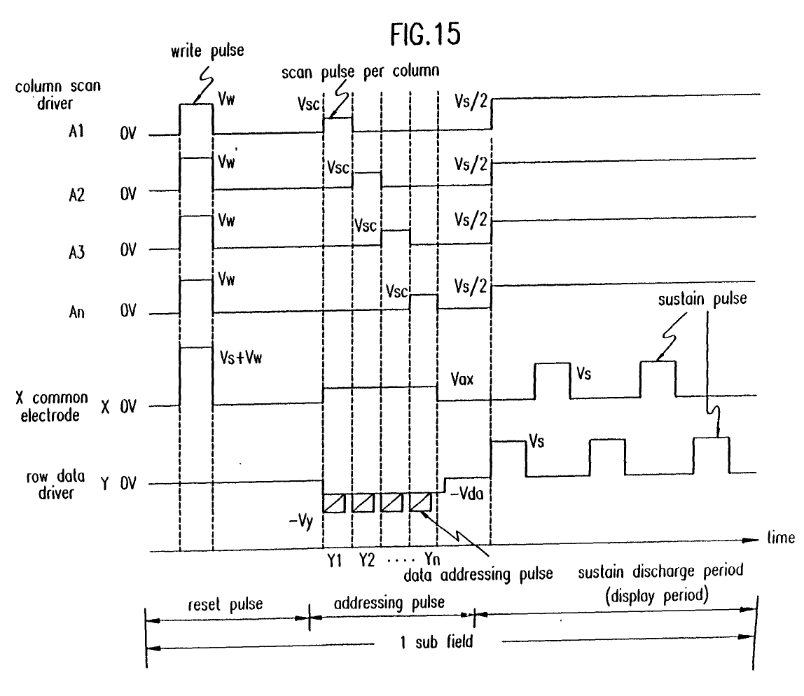

FIG. 15 is a timing chart illustrating operation in which data loading time is reduced in the driving method of FIG. 14.

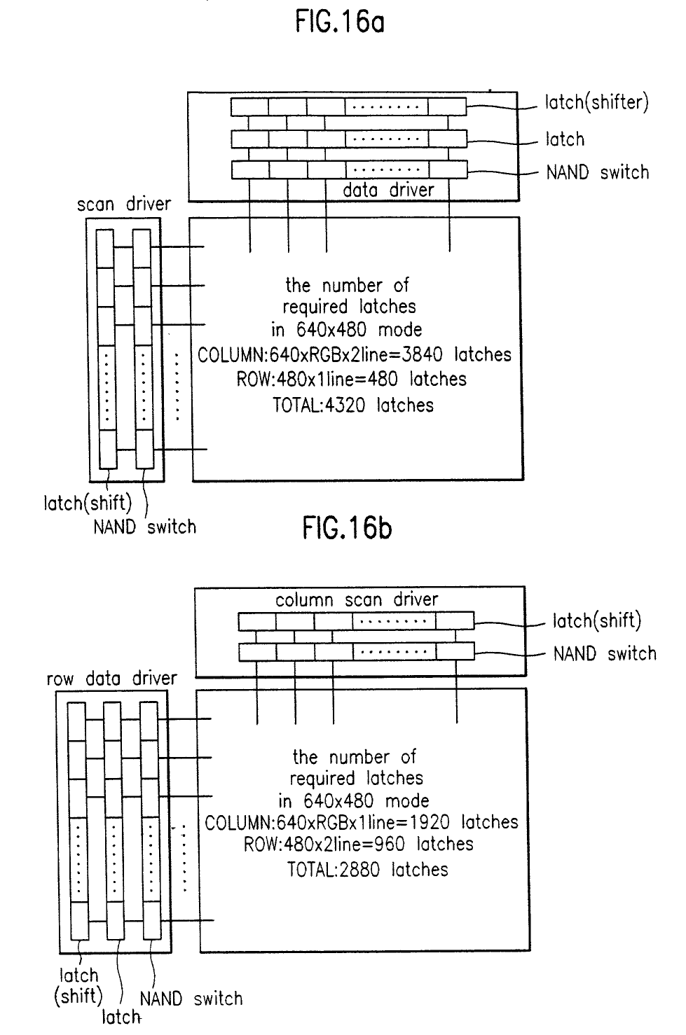

FIGS. 16a and 16b are comparative views illustrating the number of latches using in the apparatus for driving a PDP according to the present invention. It is noted that in 640× 480 mode, the apparatus for driving the PDP of the present invention includes 2880 latches as compared to 4320 latches of the conventional apparatus for driving the PDP.

The apparatus for driving the PDP module according to the present invention has the following advantages.

In the present invention, the scan driving operation is performed using the column electrode lines, and the video data addressing is performed using the row electrode lines. Therefore, the number of the latches using in each drive can be reduced, thereby simplifying circuits and improving application of the PDP module. In addition, the number of the latches for use in driving circuits can be reduced, thereby reducing the cost.

It will be apparent to those skilled in the art that various modifications and variations can be made in the apparatus for driving the PDP according to the present invention without departing from the spirit or scope of the invention. Thus, it is intended that the present invention covers the modifications and variations of the invention provided they come within the scope of the appended claims and their equivalents.

What is claimed is:

1. An apparatus for driving a plasma display panel, comprising:
a display panel having a plurality of column electrodes and row electrodes;
a row data driver coupled to the row electrodes, and applying video data to the row electrodes;
a column scan driver coupled to the column electrodes, and applying scan data to the column electrodes;
a control circuit controlling each of system configuration blocks including the row data driver and the column scan driver;
X and Y common drivers coupled to the control circuit, and applying driving signals to common electrodes of the display panel; and
a power supply circuit for supplying voltages to each of the system configuration blocks.

2. The apparatus according to claim 1, wherein the voltages include a sustain voltage applied to the X and Y common drivers, a voltage for total writing in each cell, a voltage for scanning operation for selecting each cell, and a voltage for addressing each cell.

3. The apparatus according to claim 1, wherein the control circuit receives video data, a clock signal, a horizontal synchronous signal, and a vertical synchronous signal.

4. The apparatus according to claim 1, wherein the column scan driver and the row data driver include a plurality of registers.

5. The apparatus according to claim 4, wherein the registers of the column scan driver include shift selectors for a line scan.

6. The apparatus according to claim 4, wherein the registers of the row data driver shift and store the video data.

7. The apparatus according to claim 1 wherein, the row data driver latches the video data from the control circuit and loads the video data to a selected column electrode through addressing discharge when one of the column electrodes is selected by the column scan driver.

8. An apparatus for driving a plasma display panel, comprising:
a display panel having a plurality of column electrodes and row electodes;
a control circuit generating control signals according to externally applied video data, a clock signal, a vertical synchronous signal, and a horizontal synchronous signal;
a row data driver latching the video data, and providing a row electrode driving voltage to the row electrodes;
a column scan driver coupled to the control circuit and receiving a shift pulse and providing a column electrode driving voltage to the column electrodes;
X and Y common drivers coupled to the control circuit, and applying driving signals to common electrodes of the display panel; and
a power supply circuit for supplying voltages to each of the system configuration blocks.

9. The apparatus according to claim 8, wherein the row data driver includes a shift register, a latch circuit, and a row electrode drive circuit serially connected to one another.

10. The apparatus according to claim 8, wherein the column scan driver includes a shift register and a column electrode drive circuit serially connected to each other.
